(19) United States
(12) Patent Application Publication
(10) Pub. No.: US 2026/0034495 A1
(43) Pub. Date: Feb. 5, 2026

(54) CLEANING DEVICE FOR EXHAUST AIR OF AN APPARATUS FOR MACHINING COMPOSITE-MATERIAL WORKPIECES CONTAINING METAL AND NON-METAL

(71) Applicant: Uniflex-Hydraulik GmbH, Karben (DE)

(72) Inventors: Alexander SCHNELL, Echzell (DE); Carsten BAUMGARTNER, Laubach (DE); Patrick STICKER, Bad Vilbel (DE)

(73) Assignee: Uniflex-Hydraulik GmbH, Karben (DE)

(21) Appl. No.: 19/355,553

(22) Filed: Oct. 10, 2025

Related U.S. Application Data
(63) Continuation of application No. PCT/EP2024/059523, filed on Apr. 8, 2024.

(30) Foreign Application Priority Data
Apr. 14, 2023 (DE) 10 2023 109 421.1

(51) Int. Cl. B01D 50/20; B01D 45/16; B01D 45/18; B01D 46/00; B01D 46/10; B01D 46/62; B01D 53/02; B04C 9/00

(52) U.S. Cl. CPC B01D 50/20; B01D 45/16; B01D 45/18; B01D 46/0036; B01D 46/0047; B01D 46/10; B01D 46/62; B01D 53/02; B04C 9/00; B01D 2253/102; B04C 2009/002; B04C 2009/005

(57) ABSTRACT

An apparatus for machining composite-material workpieces containing metal and non-metal has at least one machine which is used to machine the composite-material workpieces and which isolates shavings containing metal and non-metal or isolates other particles, and a suction and cleaning device for air contaminated with such particles. The suction and cleaning device has a fan and, arranged in fluidic sequence for multi-stage cleaning of the contaminated air, a cyclone separation stage, at least two mechanical filter stages and an activated carbon filter stage. The cyclone separation stage has a packet of at least three, preferably at least six, individual cyclones fluidically connected in parallel, which are arranged around a feed which supplies them via a distribution star. The individual cyclones have upwardly directed outlets for cleaned air; and above the outlets of the individual cyclones, a first of the mechanical filter stages is arranged engaging around the allocated feed.

### CROSS REFERENCE TO RELATED APPLICATIONS

This application is a continuation under 35 U.S.C. § 120 of International Application PCT/EP2024/059523, filed Apr. 8, 2024, which claims priority to German Application No. 10 2023 109 421.1, filed Apr. 14, 2023, the contents of each of which are incorporated by reference herein.

### FIELD OF THE INVENTION

The present invention relates to an installation for processing composite workpieces containing metal and non-metal, comprising a machine that functions for processing of such composite workpieces and that emits chips or other particles containing metal and non-metal, as well as an extraction and cleaning device for air contaminated with such particles, wherein the extraction and cleaning device comprises a blower and, for multi-stage cleaning of the particle-laden air in full flow in a flow-related sequence, a cyclone separator stage, at least two mechanical filter stages and an activated carbon filter stage, through which the flow is passed.

### BACKGROUND

During cutting or separating or other mechanical processing-taking place with formation of chips or dust—of such composite workpieces that contain or consist of metal (e.g. ferrous metal) as well as non-metal (e.g. plastic, latex, rubber or the like), vapors, fumes and/or smoke are typically produced. The vapor, fume or smoke formation in question is frequently associated with the fact that relatively high temperatures are produced during the processing of the metallic material, so that the chips being formed frequently even glow. At the corresponding temperatures, the non-metallic material evaporates/burns, likewise with formation of vapors, fumes and/or smoke. Because of the relatively large surface area, this generation of vapors, fumes and/or smoke is particularly intensive when non-metallic portions of the material adhere to and evaporate on the hot or possibly glowing metal chips being formed during workpiece processing.

For protection of the machine personnel and other persons present in the vicinity of the respective processing machine, any spread of the vapors, fumes or smoke being formed must absolutely be prevented. Thus the machines in question are frequently equipped with extraction systems, which convey the air laden with vapors, fumes or smoke into the open. This practice, however, is not only to be regarded as direct environmental pollution and for that reason as questionable. It is also energetically harmful, since heat is lost-unless heat recovery is provided-via the extracted air, and so correspondingly intensive reheating must be provided in the operating buildings in question.

Against this background, concepts exist for subjecting the extracted air contaminated with vapors, fumes and/or smoke and typically additionally containing metal chips (which possibly are still glowing) to cleaning close to the machine, and for releasing the air purified in this way back into the operating building. Corresponding extraction and cleaning devices such as already being used now as part of generic installations for processing of composite workpieces containing metal and non-metal and thus presumed to be known belong, for example, to the current supply program of the Applicant (Uniflex-Hydraulik GmbH, Karben).

### SUMMARY

The present disclosure is aimed at contributing a further improvement of workplace hygiene for generic installations for processing of composite workpieces containing metal and non-metal as well as further improvements that have relevance for practice compared with the prior art. In particular, the disclosure relates to improving the currently existing situation in terms of the totality of requirements relevant to practice, such as air quality (in the sense of cleaning capacity of the extraction and cleaning device), energetic efficiency, space requirement, flexibility of the extraction and cleaning device in terms of changing requirements, noise protection and maintenance expense, wherein the stated individual objectives are obviously in conflict with each other to some extent.

This object is achieved according to the present disclosure in that, in an installation of the generic type for processing of composite workpieces containing metal and non-metal, the cyclone separator stage has at least one package of at least three, preferably at least six individual cyclones connected in parallel with each other in terms of flow and arranged around an inlet supplying them via a distributor star, wherein the individual cyclones have upwardly directed outlets for the purified air, and in that a first of the mechanical filter stages is arranged above the outlets of the individual cyclones in a manner embracing the associated inlet. In other words, especially the following combination of features that characterise the extraction and cleaning device and interact synergistically with each other as well as with the other technical features of the installation for processing of composite workpieces containing metal and non-metal is provided for the disclosed installation for processing of composite workpieces containing metal and non-metal:
The cyclone separator stage (or at least one cyclone separator stage) comprises at least one package of at least three, preferably at least six individual cyclones connected in parallel with each other in terms of flow. Advantageously, these individual cyclones of the package in question not only are connected in parallel with each other in terms of flow but also are arranged (in a common plane) in a manner structurally in parallel with each other.
These at least three, preferably at least six (particularly preferably eight) individual cyclones of the package in question are arranged around a (common) inlet, which supplies them via a distributor star, and they have upwardly directed outlets for the purified air. Advantageously, these individual cyclones are arranged in upright manner, i.e. with vertical or at least substantially vertical axis (e.g. inclined by up to 30° relative to the vertical), so that the purified air exits the respective individual cyclone through the respectively associated outlet, in a manner directed more or less vertically upward.
A first of the mechanical filter stages is arranged above the outlets of the individual cyclones. This first mechanical filter stage, which embraces the inlet associated with the package in question of individual cyclones, is therefore supplied on the shortest path from the outlets of the individual cyclones. Ideally, from the outlets of the individual cyclones, a direct and immediate supply of the first of the mechanical filter stages connected downstream from the cyclone separator stage then exists, without prior deflection of the flow.

As a result, diverse advantages of distinct high relevance to practice are obtained due to the disclosed design of the installation for processing of composite workpieces containing metal and non-metal. Due to the larger—compared with an individual cyclone of comparable air throughput—surface area of the at least three, preferably six, particularly preferably eight individual cyclones of a package, any chips still glowing are extinguished with high reliability upon entering the cleaning device; this reduces the danger of damage to downstream filter stages.

Due to the configuration of the cyclone separator stage and of the first mechanical filter stage connected downstream from this and to the specific spatial arrangements of this components relative to each other, the noise generation can be substantially reduced compared with the prior art. In addition, these features contribute to the fact that the extraction and cleaning device—in the sense of high flexibility of use—also has a similarly high cleaning capacity even for considerably different air throughputs and—despite its outstanding performance capability—has an only very small space requirement. The high flexibility in turn is directly also a decisive efficiency factor, since the high cleaning capacity even in the partial load range permits operation of the extraction and cleaning device—without losses of effectiveness—with reduced air throughput, whereby operating costs can be saved and maintenance intervals can be extended.

According to a first preferred further improvement of the present invention, the first mechanical filter stage comprises a C-shaped filter disc having a sideways directed recess, wherein the recess of the filter disc receives the associated inlet. Due to the C-shape, the filter disc can be removed and installed easily and without problems—especially without the need to demount the inlet of the associated cyclone package. In particular, the filter disc can be removed sideways from the installation position, wherein the inlet emerges sideways from the recess of the filter disc; insertion of the filter disc takes place in the reverse sequence. Thus maintenance of the first, typically most severely stressed mechanical filter stage is possible with minimum effort. And the regular maintenance made economically possible in this way has a positive impact on the effectiveness. Taking into consideration the design of the (C-shaped) filter disc explained in the foregoing, the first mechanical filter stage, in a further preferred configuration of the invention, is housed in a housing, which in turn has a sideways directed recess, wherein the recess of the housing receives the associated inlet.

Another preferred further improvement of the inventive installation is characterised in that the first mechanical filter stage is housed in a housing that has upper outlet openings adjacent to an entrance of the associated inlet, as well as sideways outlet openings on its circumference. It has been shown that the provision of outlet openings both on the axial end-associated with the entrance of the associated inlet—of the housing and also on its circumference is highly favorable, both from viewpoints of minimum noise generation and also in terms of very good cleaning results over a broad operating range.

According to yet another preferred further improvement of the invention, the extraction and cleaning device comprises two chambers arranged adjacent to each other, wherein there is arranged, adjacent to a first chamber that accommodates the cyclone separator stage and the first mechanical filter stage, a second chamber, which accommodates a second mechanical filter stage connected downstream from the first mechanical filter stage in terms of flow. These two chambers are advantageously separated from each other by a partition wall or a separating or guide plate, wherein this plate or this partition wall obviously imposes not a complete but “only” an extensive separation of the two chambers from each other, since it is still intended by definition as a flow path for the air to be purified from the first chamber into the second chamber. For this purpose, the partition wall or the separating or guide plate may have in particular a penetration or a recess, at which or at its edge a sharp deflection of the flow takes place. Ideally, the partition wall (or a separating or guide plate present there) arranged between the first chamber and the second chamber has a flow-around edge that imposes a flow deflection of at least 90° for the air flow passing from the first into the second chamber. This favors deposition of contamination discharged with the air flow from the first mechanical filter stage on the path to the second mechanical filter stage.

Concerning the second mechanical filter stage, it preferably has at least one pot filter, through which the flow passes radially from outside to inside, and which has an upwardly directed outlet. The air flow then exits the second mechanical filter stage preferably more or less vertically in upward direction.

Particularly preferably, at least two such pot filter are provided, specifically in a flow-related parallel arrangement relative to each other. Particularly preferably, the at least one pot filter is then surrounded on its outer side by a prefilter jacket, wherein a multi-layered construction of the prefilter jacket has proved to be quite particularly favorable

Such prefilter jackets with at least one layer consisting of a filter fleece and with a layer consisting of a filter foam (e.g. of PU foam) have particularly favorable properties. The foregoing technical viewpoints have a positive impact, especially in terms of the (high) cleaning capacity, the (low) noise generation and the (low) maintenance expense.

According to yet another preferred further improvement of the present invention, in such cleaning devices which—in the foregoing sense—have in addition to a first and a second chamber arranged adjacent to it, there is extended, above the first and the second chamber, a third mechanical filter stage connected downstream from the second mechanical filter stage in terms of flow. The third mechanical cleaning stage, through which preferably the flow passes once again more or less vertically from bottom to top, has, because it is extended above the first as well as the second chamber, a greater flow cross section than the second mechanical filter stage. This results in a reduction of the flow velocity of the air flow to be purified in flow direction, which in turn is very advantageous in terms of noise generation of the cleaning device, namely of the noise emitted by the air flow exiting the cleaning device.

Yet another preferred further improvement of the inventive installation for processing of composite workpieces containing metal and non-metal is characterised in that the blower of the extraction and cleaning device comprises a drive motor, which is accommodated in an installation space bounded by a wall, wherein the wall separates the motor installation space from a space of the activated carbon filter filled with activated carbon. In other words, in this further improvement, the motor installation space, in which the drive motor for the blower is accommodated, is more or less embedded in the activated carbon filter, namely is surrounded at least partly by the space filled with activated carbon. Hereby substantial positive impacts are again achieved in the sound-related respect; since the activated carbon contributes to active, effective damping of the sound emitted by the blower drive motor. After the activated carbon stage has been arranged downstream from the blower, i.e. on its pressure side, the activated carbon additionally effectively damps the sound generated by the blower itself-which is arranged upstream from the activated carbon stage.

Finally, again under viewpoints of particularly easy maintenance, a coarse dirt tray is particularly preferably arranged below the individual cyclones. The individual cyclones are then able to empty the particles separated from the air flow to be purified into the coarse dirt tray by means of gravity alone. As regards the longest possible maintenance intervals, the coarse dirt tray advantageously has a large load capacity and, in order to achieve easy maintenance, is equipped with rollers. Particularly preferably, a body of the extraction and cleaning device then has a lifting device that functions for lifting and lowering the coarse dirt tray. This ensures that the coarse dirt tray can be moved easily and conveniently into an operating position lifted away from the floor and sealing the dirt collection space reliably tightly toward the outside. The coarse dirt tray lifted in such a way does not hinder the movement of the extraction and cleaning device, provided this in turn is designed in the individual case to be mobile, i.e. is equipped with rollers.

### BRIEF DESCRIPTION OF THE DRAWING

The present invention will be explained in detail in the following on the basis of a preferred exemplary embodiment illustrated in the drawing, wherein

FIG. 1 shows an installation for processing composite workpieces containing metal and non-metal with a machine, designed as a hose cutting machine for processing of composite workpieces containing metal and non-metal, together with an extraction and cleaning device for air, which is contaminated with chips containing metal and non-metal or other particles emitted by the hose cutting machine,

FIG. 2 shows the air extraction and cleaning device constructed in the installation according to FIG. 1, in top view on the suction side,

FIG. 3 shows a vertical section through the air extraction and cleaning device according to FIG. 2 along line III-III in FIG. 2,

FIG. 4 shows a vertical section through the air extraction and cleaning device according to FIGS. 2 and 3, in a plane rotated by 90° relative to FIG. 3, along line IV-IV in FIG. 3,

FIG. 5 shows the air extraction and cleaning device according to FIGS. 2 to 4, along the section line according to FIG. 3, in perspective view obliquely from above,

FIG. 6 shows the air extraction and cleaning device according to FIGS. 2 to 5, along the section line according to FIG. 4, in perspective view obliquely from below,

FIG. 7 shows the air extraction and cleaning device according to FIGS. 2 to 5, along the section line according to FIG. 4, in perspective view obliquely from above, and

FIG. 8 and FIG. 9 illustrates, in greater detail, the construction and mode of operation of the lifting device for the coarse dirt tray.

### DETAILED DESCRIPTION OF THE PREFERRED EMBODIMENTS

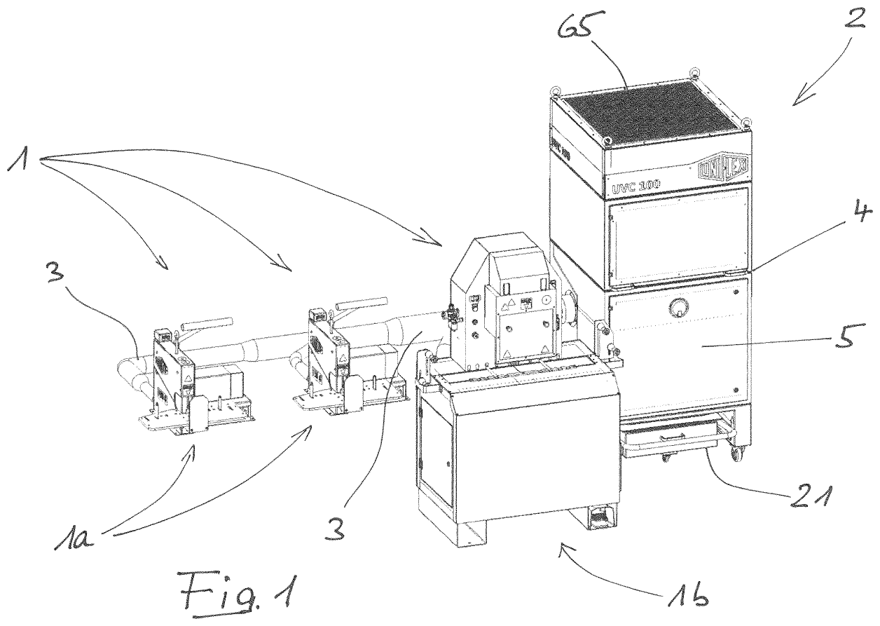

The installation shown in FIG. 1 for processing composite workpieces containing metal and non-metal comprises several machines 1 functioning for processing of such, composite workpieces, namely three hose cutting machines 1a, 1b intended for cutting through reinforced high pressure hydraulic hoses. Furthermore, the shown installation comprises an extraction and cleaning device 2 for air, which is contaminated with chips or other particles containing metal and non-metal emitted by the hose cutting machines 1a, 1b. For this purpose, the extraction and cleaning device 2 is connected to the three hose cutting machines 1a, 1b via extraction lines 3.

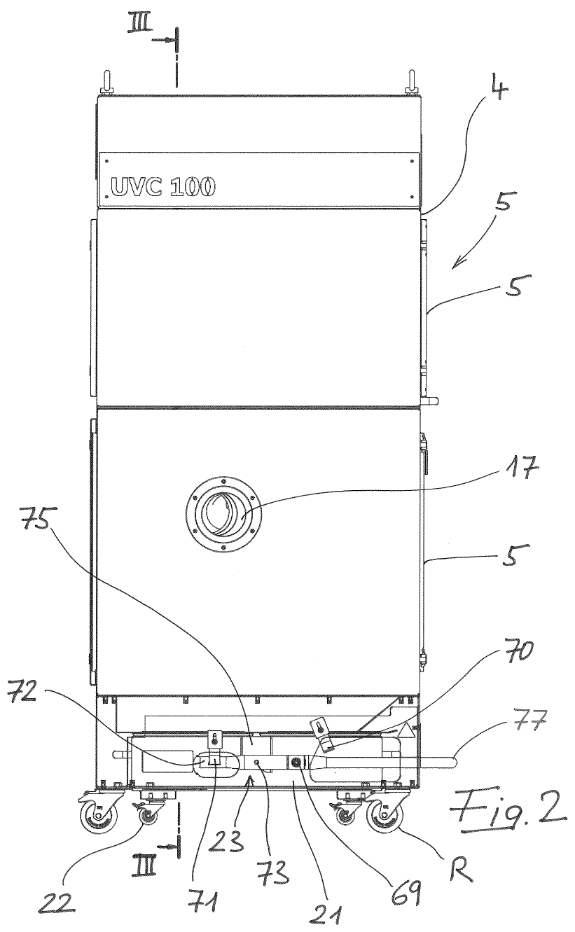

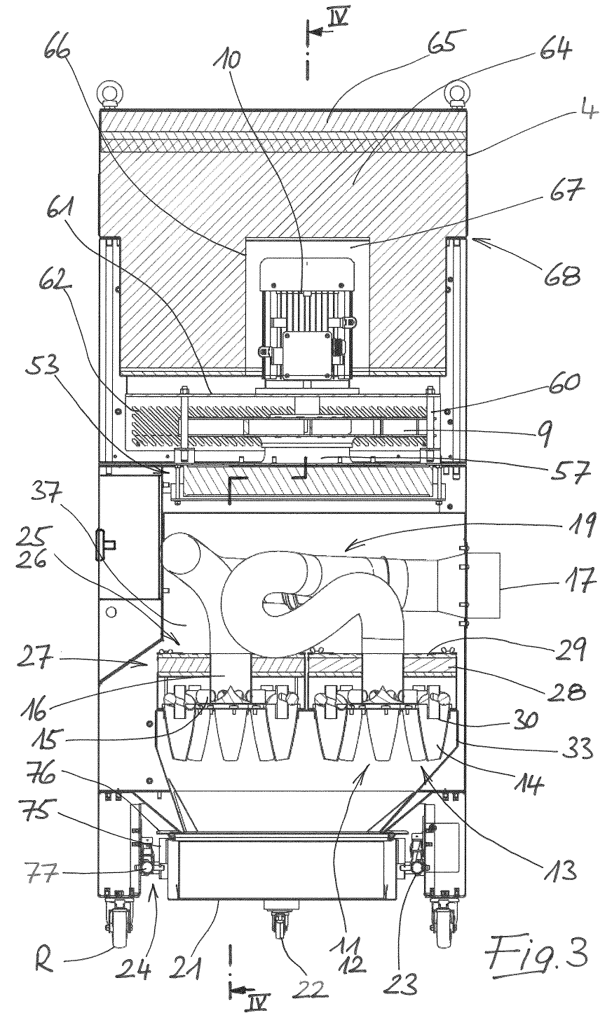

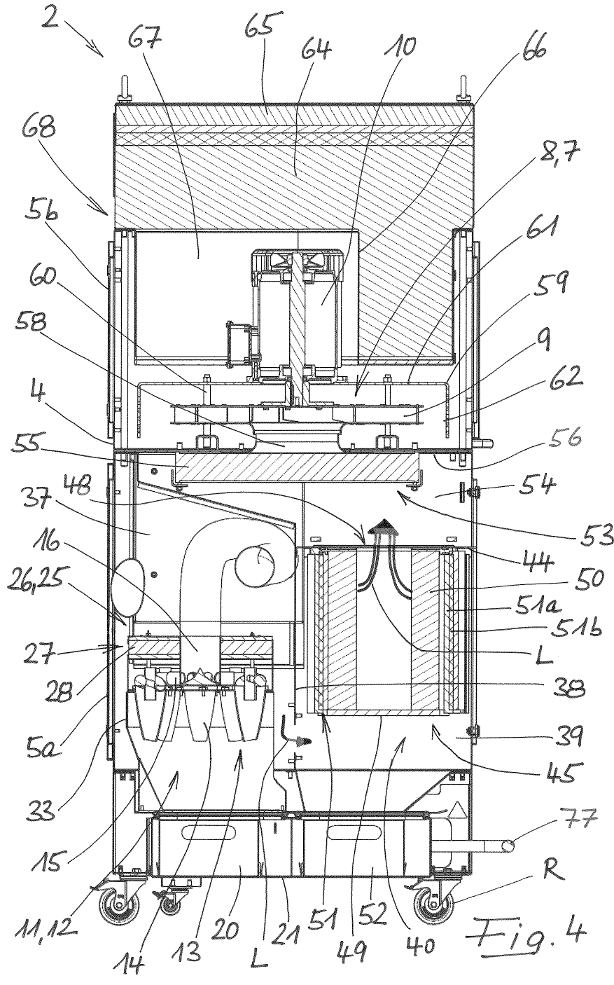

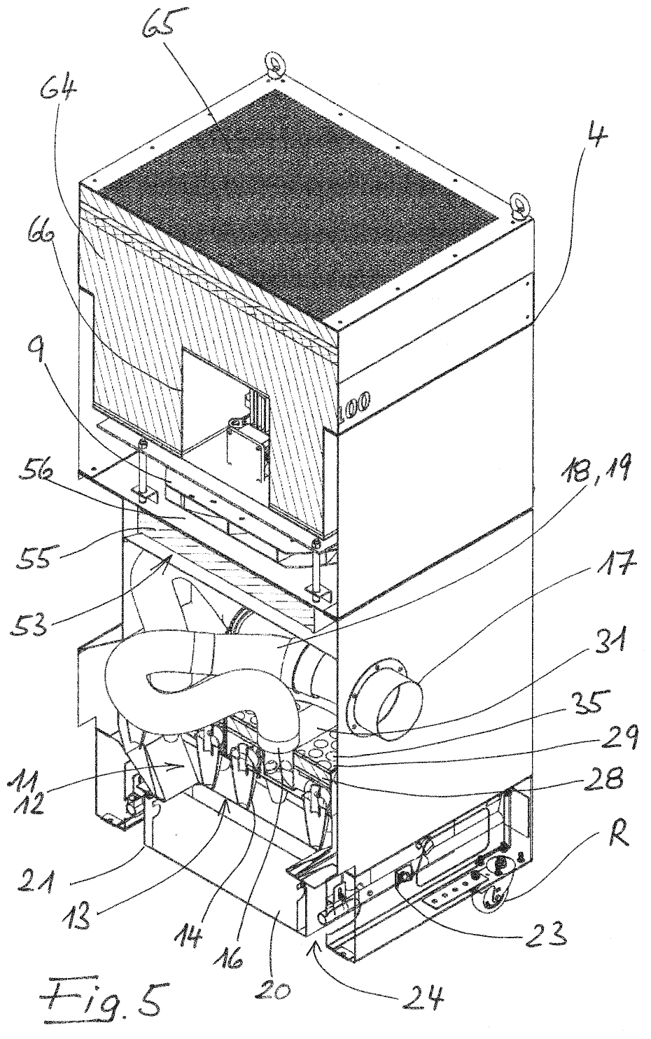

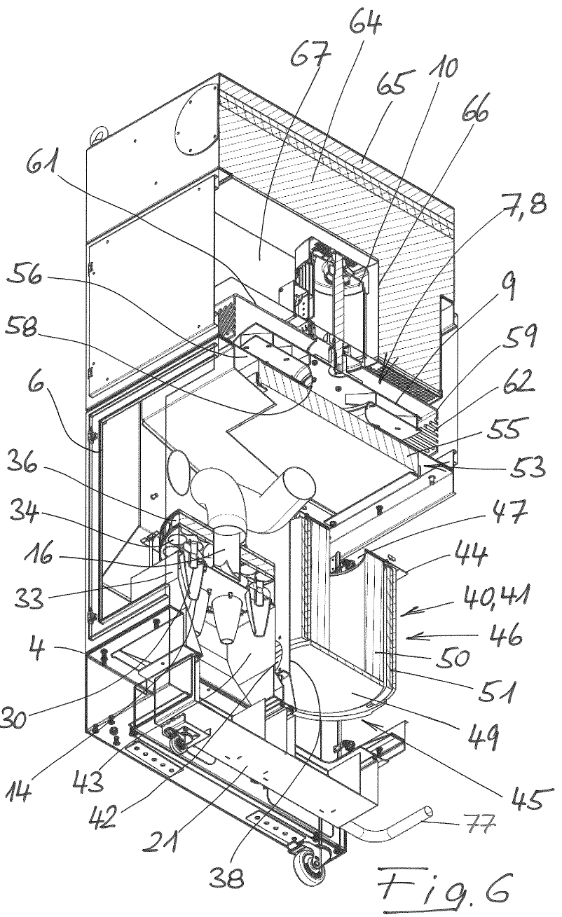

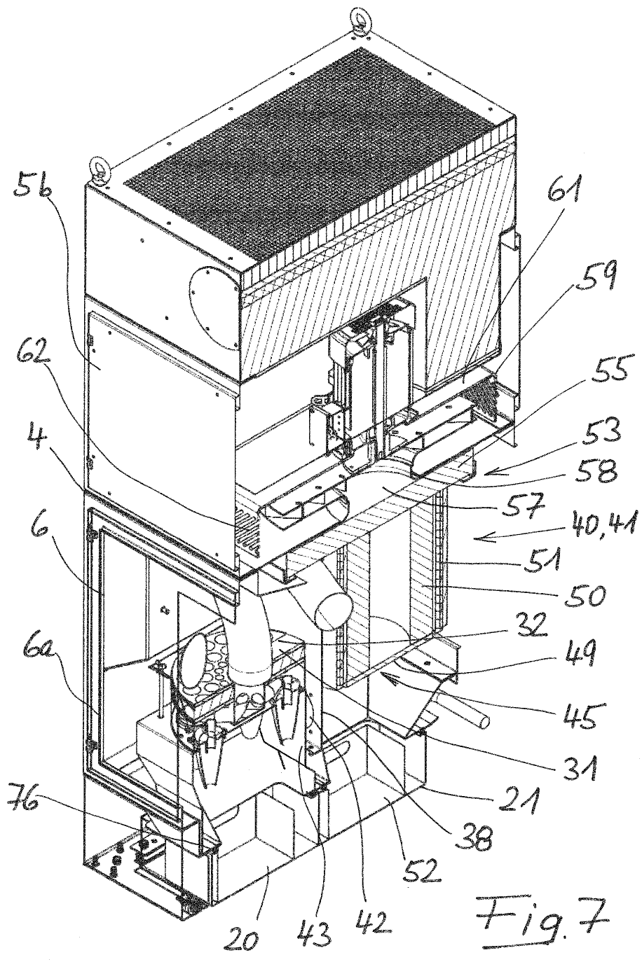

The air extraction and cleaning device 2 shown in detail in FIGS. 2 to 7 has an approximately cubic or cuboid basic shape. It comprises a housing-like body 4—mounted upright on wheels R—with several maintenance openings 6, which are closed by means of covers 5, and through which the various aggregates are accessible-especially for maintenance purposes. Extraction of air by the hose cutting machines 1a, 1b and conveyance of the extracted air through five cleaning stages (see below) are then ensured by a blower 7, which is designed as a radial blower 8, wherein the fan wheel 9 is driven in rotation around the upright axis by the associated motor 10 arranged above the fan wheel 9.

The air flow L conveyed through the air extraction and cleaning device passes in full flow in a flow-related sequence through a total of five cleaning stages. Of those, four are arranged upstream from the blower 7, on its suction side, and one downstream from the blower 7, on its pressure side.

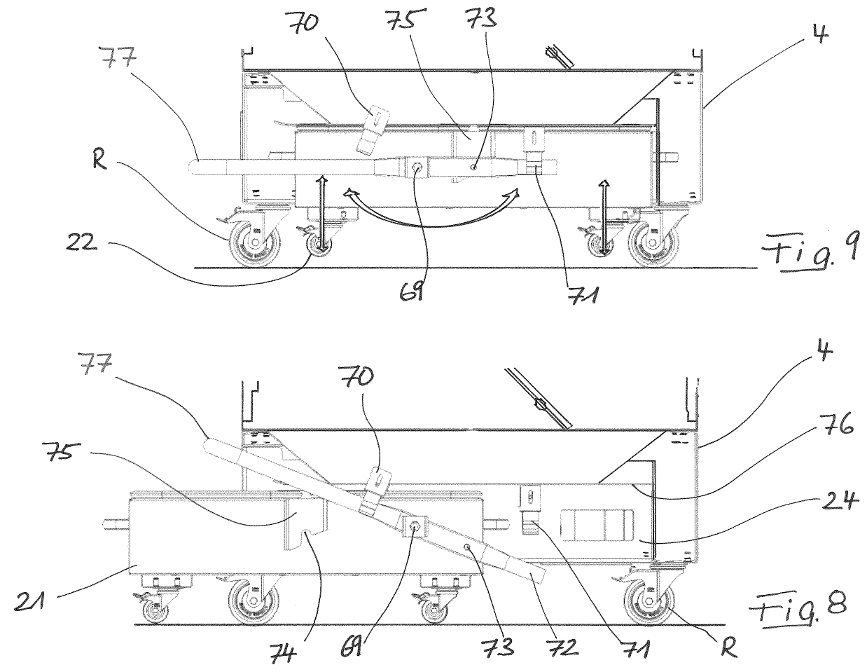

The first cleaning stage 11 is then designed as a cyclone separator stage 12. It comprises two packages 13—connected in parallel with each other in terms of flow—of respectively eight individual cyclones 14, connected in parallel with each other in terms of flow. In each of the two packages 13, the eight individual cyclones 14 are arranged around an inlet 16 supplying them via a distributor star 15, wherein the two inlets 16 are supplied by the extraction nozzles 17 via a branch 19 designed as a hose pipe 18. A first compartment 20 of a coarse dirt tray 21 is arranged below the individual cyclones 14. This is designed in the manner of drawers for easier handling and is equipped with rollers 22, wherein a lifting device 23 (see also FIGS. 8 and 9) functioning for lifting and lowering of the coarse dirt tray 21 acts between the body 4 of the extraction and cleaning device 2 and the coarse dirt tray 21. In the operating position-shown in FIGS. 1-7 and 9—of the coarse dirt tray 21 inserted into a corresponding free space 24 of the body 4 of the extraction and cleaning device 2, its rollers 22 are thus lifted away from the floor.

The second cleaning stage 25 is designed as a first mechanical filter stage 26 arranged directly above the first cleaning stage 11 described in the foregoing. And, in fact, above each of the two individual cyclone packages 13, there is provided a filter element 27, which comprises a filter disc 28—constructed with a sideways, i.e. C-shaped recess—having a perforated housing 29 that surrounds it-on both axial ends as well as at the circumference—and which is supplied directly from below with a flow of air, which exits the associated individual cyclones 14 through their upwardly directed dip tubes 30 (“outlets”). Each filter element 27 embraces the inlet 16 of the associated individual cyclone package 13, in that this (plus the filling piece 31 attached to it) is received in the sideways directed recess 32 of the C-shaped filter element 27 in question. Thus, for maintenance purposes, the C-shaped filter element can be pulled sideways from its installation position or inserted into it, without necessitating extensive demounting of the air extraction and cleaning device 2, wherein the body 4 has, for the purpose of the corresponding change of filter, a maintenance opening 6a—which can be closed by a cover 5a. The filter disc 28 is of three-layer construction and consists, in the manner of a sandwich, of a central foam layer and two fleece layers surrounding it. By virtue of its perforation, the housing 29 of the filter element 27—seated tightly on the housing 33 (which is open downward to the coarse dirt tray 21)—has lower inlet openings 34 and upper outlet openings 35 as well as—on its circumference—sideways outlet openings 36.

The air purified in the first mechanical filter stage 26 and exiting the respective filter element 27 through the said outlet openings 35, 36 passes into the area, free of internal parts, of a first chamber 37, which accommodates the cyclone separator stage 12 and the first mechanical filter stage 26 and is separated by a partition wall 38 from a second chamber 39, which is situated adjacent to it and in which a second mechanical filter stage 40—connected in flow-related manner downstream from the first mechanical filter stage 26—is accommodated that forms the third cleaning stage 41. The second chamber 39 is connected in this case with the first chamber 37 by flow-through openings 42 arranged in the lower area of the partition wall 38. Air is then conveyed through a guide plate 43 associated with the housing 33 of the individual cyclone package 13 in such a way that an abrupt flow deflection of the air flow passing from the first chamber 37 into the second chamber 39 takes place in the upper area of the flow-around edge bounding the flow-through opening 42.

The second mechanical filter stage 40 has two pot filters 45 attached to the closure wall 44 bounding the second chamber 39 in upward direction, with respectively a cylindrical filter unit 46, through which flow passes radially from outside to inside, and an upwardly directed outlet 48 aligned with a corresponding penetration 47 of the closure wall 44. The respective filter unit 46 then comprises a cylindrical filter element 50 (“cartridge filter”), which consists of polyester fiber filter fabric and is accommodated in a cylindrical, perforated steel plate housing closed at its lower end by a cover 49, as well as an easily exchangeable two layer prefilter element 51 surrounding this on the outside and having an inner layer 51a (e.g. M5 filter mat) consisting of a filter fleece as well as an outer layer 51b consisting of an open-pored filter foam (e.g. PPI 15). A second compartment 52 of the coarse dirt tray 21 is located below the second mechanical filter stage. The second compartment 52, just as the first compartment 20, is designed as a separate insert accommodated in the coarse dirt tray 21, thus favoring rapid and simple emptying.

The air flowing upward away from the two pot filters 45 of the second mechanical filter stage 40 passes to the third mechanical filter stage 53. This comprises a rectangular plate-shaped HEPA filter element 55, which is arranged in a third chamber 54 extending above the first chamber 37 and the second chamber 39 and through which flow passes from bottom to top. This is arranged in a manner covering a large surface area above the first and the second mechanical filter stage 26, 40 on the underside of a separating plate 56, which bounds the third chamber 54 at the top, separates an upper area of the extraction and cleaning device 2 from a lower area that includes the first, the second and the third chambers 37, 39, 54 and has a central penetration opening 57, which is bounded by a collar 58 forming the inlet area of the radial blower 8. The electric motor 10 driving the fan wheel 9 of the radial blower 8 is mounted on a flow guide plate 59, which is attached by means of several bolts 60 to the separating plate 56 and has two perforated side walls 62 that protrude in downwardly angled manner from an upper section 61 supporting the electric motor 10. Thus the flow guide plate 59 surrounds the fan wheel 9 and ensures calming of the air flow exiting the radial blower 8.

An activated carbon filter stage 68, which extends over the entire cross section of the upper area of the extraction and cleaning device 2 and has an activated carbon filter 64 plus multi-layer covering 65 of fleece and foam on the downstream side, forms, as a fifth cleaning stage 63, the upper closure of the extraction and cleaning device 2. The drive motor 10 of the radial blower 9 is in this case accommodated in an installation space 67 recessed in the activated carbon filter 64 and bounded by a wall 66, wherein the said wall 66 separates the motor installation space 67 from a space of the activated carbon filter 64 filled with activated carbon. The motor 10 is accessible through a maintenance opening 6b that can be closed by means of a cover 5b.

The lifting device 23 for the coarse dirt tray 21, by means of which the latter can be lifted into an operating position lifted away from the floor and sealingly closing the dirt collection space surrounding the first compartment 20 and the second compartment 52, is illustrated in more detail in FIGS. 8 and 9. An approximately U-shaped bail 77 is supported in pivotable manner on the body 4 around a horizontal pivot axis 69, wherein the possible pivoting angle is determined by two stops 70, 71 respectively defining an end position. These two stops 70, 71 are respectively provided with an integrated clamping retainer, which cooperates with the bail 77 and acts to lock the bail 77 in the respective end position. Pin-shaped driving members sticking out toward the inside 73 are respectively arranged on the two free sections 72 of the bail 77 extending beyond the pivot axis 69. When the coarse dirt tray 21 is introduced completely into the corresponding free space 24 of the body 4, these driving members 73 respectively engage in an associated recess 74 of an associated mating piece 75 provided laterally on the coarse dirt tray 21, so that, upon pivoting of the bail 77 from its first end position illustrated in FIG. 8 into its second end position shown in FIG. 9, the coarse dirt tray 21 is lifted away from the floor and lifted sufficiently far that its upper edge fits sealingly on a corresponding structure 76 of the body 4.

What is claimed is:

1. Installation for processing composite workpieces containing metal and non-metal, comprising
at least one machine (1) for processing such composite workpieces, which emits chips or other particles containing metal and non-metal, and
an extraction and cleaning device (2) for air contaminated with such particles,
wherein the extraction and cleaning device (2) has a blower (7) and, for multi-stage cleaning of the particle-laden air in full flow in a flow-related sequence, a cyclone separation stage (12), at least two mechanical filter stages (26, 40, 53) and an activated carbon filter stage (68),
wherein the cyclone separation stage (12) has at least one package (13) of at least three, preferably at least six individual cyclones (14) connected in parallel with each other in terms of flow, which are arranged around an inlet (16) supplying them via a distributor star (15), wherein the individual cyclones (14) have upwardly directed outlets for the purified air, and that above the outlets of the individual cyclones (14), a first (26) of the mechanical filter stages (26, 40, 53) is arranged embracing the associated inlet (16).

2. The installation of claim 1, wherein the first mechanical filter stage (26) comprises a C-shaped filter disc (28) with a sideways recess (32), wherein the recess (32) of the filter disc (28) accommodates the associated inlet (16).

3. The installation of claim 2, wherein the first mechanical filter stage (26) is housed in a housing (29) which in turn has a sideways recess, the recess of the housing (29) receiving the associated inlet (16).

4. The installation of claim 1, wherein the first mechanical filter stage (26) is housed in a housing (29) which has upper outlet openings (35) adjacent to an entrance of the associated inlet (16) and lateral outlet openings (36) on its circumference.

5. The installation of claim 1, wherein next to a first chamber (37) accommodating the cyclone separation stage (12) and the first mechanical filter stage (26), a second chamber (39) is arranged which accommodates a second mechanical filter stage (40) connected downstream to the first mechanical filter stage (26) in terms of flow.

6. The installation of claim 5, wherein the second mechanical filter stage (40) has at least one pot filter (45) through which the flow passes radially from the outside to the inside and which has an upwardly directed outlet (48).

7. The installation of claim 6, wherein the pot filter (45) is surrounded on its outer side by a pre-filter jacket (51).

8. The installation of claim 7, wherein the pre-filter jacket (51) is multi-layered, preferably comprising a layer (51a) consisting of a filter fleece and/or a layer (51b) consisting of filter foam.

9. The installation of claim 5, wherein a partition wall (38) is arranged between the first chamber (37) and the second chamber (39), which has a flow-around edge with a sharp-edged flow deflection, preferably a flow deflection of at least 90° for the air flow (L) passing from the first chamber (37) into the second chamber (39).

10. The installation of claim 5, wherein a third mechanical filter stage (53) is arranged above the first chamber (37) and the second chamber (39) and is connected downstream to the second mechanical filter stage (40) in terms of flow.

11. The installation of claim 1, wherein the blower (7) comprises a drive motor (10) which is accommodated in an installation space (67) bounded by a wall (66), the wall (66) separating the motor installation space (67) from a space of the activated carbon filter (64) filled with activated carbon.

12. The installation of claim 1, wherein a coarse dirt tray (21) is arranged below the individual cyclones (14).

13. The installation of claim 12, wherein the coarse dirt tray (21) is equipped with wheels (R), wherein a lifting device (23) for lifting and lowering the coarse dirt tray (21) acts between a body (4) of the extraction and cleaning device (2) and the coarse dirt tray (21).
